(19) United States
(12) Patent Application Publication
(10) Pub. No.: US 2024/0401760 A1
(43) Pub. Date: Dec. 5, 2024

(54) SURFACE LIGHT SOURCE

(71) Applicant: KANEKA CORPORATION, Osaka-shi, Osaka (JP)

(72) Inventors: Youichi YAMAGUCHI, Osaka-shi (JP); Kuniharu MATSUDA, Osaka-shi (JP)

(21) Appl. No.: 18/699,115

(22) PCT Filed: Jun. 17, 2022
(86) PCT No.: PCT/JP2022/024329

§ 371 Date: Apr. 5, 2024

(30) Foreign Application Priority Data
Oct. 6, 2021 (JP) 2021-164705

(51) Int. Cl. F21S 8/00; F21V 21/08; F21V 23/06; F21W 131/402

(52) U.S. Cl. CPC F21S 8/03; F21V 21/08; F21V 23/06; F21W 2131/402

(57) ABSTRACT

The present invention provides a surface light source that can be easily attached to an existing mounting surface and has fewer restrictions on an installation place than in the related art. A surface light source has an emission surface and a back surface attached to a mounting surface such that the back surface is parallel to the mounting surface, and the surface light source includes an exterior part; a plurality of light-emitting panels; and a feeding wiring line, wherein the exterior part has one side when the emission surface is viewed in plan view, and the feeding wiring line is connected to the plurality of light-emitting panels in the exterior part, the feeding wiring line extending to an outside from an end face to which the one side of the exterior part belongs.

### TECHNICAL FIELD

The present invention relates to a surface light source having a plurality of light-emitting panels.

### BACKGROUND ART

In a workplace for inspection in a manufacturing line or the like, an inspection work for an inspection object is conventionally performed by illuminating a hand with light from a lighting device (for example, Patent Document 1).

For example, an inspection device of Patent Document 1 includes an inspection table that allows an inspection object to be placed on a top plate thereof, a lighting fixture that is located above the top plate and that illuminates the top plate as well as the inspection object, and an illuminance sensor embedded in a central position of the top plate. The lighting fixture can illuminate the inspection table at hand.

### PRIOR ART DOCUMENT

### Patent Document

Patent Document 1: JP 2012-243387 A

### DISCLOSURE OF INVENTION

### Technical Problem

Meanwhile, in the inspection device of Patent Document 1, feeding wiring lines and the like of the lighting device are embedded in the inspection device, and an installation position of the lighting device in the inspection device is fixed. Therefore, in the inspection device of Patent Document 1, the installation position of the lighting device cannot be changed even if it is desired to change the installation position of the lighting device according to the inspection item and the size of the inspection object, which leads to a problem that there is a large restriction on the installation position of the lighting device.

Therefore, an object of the present invention is to provide a surface light source that can be easily attached to an existing mounting surface and has fewer restrictions on the installation place than the conventional surface sources.

### Solution to Problem

According to an aspect of the present invention for resolving the problems, there is provided a surface light source that includes: an emission surface; and a back surface attached to a mounting surface such that the back surface is parallel to the mounting surface, the surface light source including: an exterior part; a plurality of light-emitting panels; and a feeding wiring line, wherein the exterior part has one side when the emission surface is viewed in plan view, and wherein the feeding wiring line is connected to the plurality of light-emitting panels in the exterior part, the feeding wiring line extending to an outside from an end face to which the one side of the exterior part belongs.

The “mounting surface” mentioned herein is a surface to be mounted, and refers to, for example, a wall surface of a fixed structure such as a ceiling surface, a wall surface, or a floor surface, or a wall surface of furniture such as a work desk.

According to this aspect, the feeding wiring line extends from the end face of the exterior part, and the feeding wiring line is not positioned between the back surface and the mounting surface. Therefore, the thickness of the surface light source can be made thinner than the thickness of those in the related art, and the surface light source can be attached to a desired mounting surface by fixing means such as a fastening element or an adhesive. Therefore, the surface light source can be installed on the desired mounting surface without any additional processing for fixing, and there are fewer restrictions on the installation place than in the related art.

According to a preferred aspect, the feeding wiring line includes a plug portion configured to be inserted into a commercial power supply outlet.

According to this aspect, by inserting the plug portion of the feeding wiring line into the existing commercial power supply outlet, power can be easily supplied from the existing commercial power supply outlet.

According to a preferred aspect, a maximum thickness of the exterior part is equal to or greater than 5 mm and equal to or less than 10 mm.

According to this aspect, since the exterior part is thin, the surface light source does not protrude from the mounting surface, and workability can be improved when inspection or the like is performed.

According to a preferred aspect, the exterior part has a rectangular shape when the emission surface is viewed in plan view, the plurality of light-emitting panels are arranged side by side in a longitudinal direction, and the feeding wiring line extends to an outside from an end face to which a short side of the exterior part belongs.

According to this aspect, since the feeding wiring line extends to the outside from the edge surface of the exterior part, the feeding wiring line is less likely to be an obstacle, and the width (length in the transverse direction) can be narrowed.

According to a preferred aspect, the exterior part is fixed to the mounting surface by a fastening element.

The “fastening element” mentioned herein is a superordinate concept of a screw, a nail, a rivet, and the like, and is a concept including a temporary fastening element that can be fastened and released without being broken in principle. The same applies to the following.

According to this aspect, the exterior part is easily fixed to the mounting surface.

According to a preferred aspect, a back surface of the exterior part is in surface contact with the mounting surface directly or with a sheet interposed therebetween so that the back surface is fixed to the mounting surface.

According to this aspect, since the back surface of the exterior part is supported by the mounting surface, the exterior part is hardly deformed.

According to a preferred aspect, the surface light source is for use of inspection, the surface light source emitting light to a work surface of a workbench in an inclination direction.

According to this aspect, a shadow is less likely to be formed on the work surface of the workbench.

### Effect of Invention

According to the surface light source of the present invention, the surface light source can be easily attached to an existing mounting surface and has fewer restrictions on the installation place than in the related art.

### BRIEF DESCRIPTION OF DRAWINGS

FIG. 1 is a side view schematically illustrating an installation state of a surface light source according to a first embodiment of the present invention.

FIG. 2 is a perspective view of the surface light source of FIG. 1 as viewed from a first main surface side.

FIGS. 3A and 3B are explanatory views of the surface light source of FIG. 2, in which FIG. 3A is a front view and FIG. 3B is a rear view.

FIGS. 4A to 4C are cross-sectional views of FIG. 3A, in which FIG. 4A is a cross-sectional view taken along line A-A, FIG. 4B is a cross-sectional view taken along line B-B, and FIG. 4C is a cross-sectional view taken along line C-C.

FIG. 5 is an exploded perspective view of the surface light source of FIG. 2 as viewed from a second main surface side.

FIG. 6 is an exploded perspective view of a light-emitting unit of FIG. 5.

FIG. 7 is an exploded perspective view of the light-emitting unit of FIG. 5 as viewed from the first main surface side.

FIG. 8 is a perspective view of a casing part of FIG. 5 as viewed from the first main surface side.

FIG. 9 is an exploded perspective view of the periphery of an end face-side cover part of FIG. 5.

FIG. 10 is a perspective view of a surface light source according to a second embodiment of the present invention as viewed from the first main surface side.

FIGS. 11A and 11B are cross-sectional views of the surface light source of FIG. 10, in which FIG. 11A is a cross-sectional view taken along line D-D, and FIG. 11B is a cross-sectional view taken along line E-E.

FIG. 12 is an exploded perspective view of the surface light source of FIG. 10 as viewed from the second main surface side.

FIG. 13 is an exploded perspective view of a light-emitting unit of FIG. 12.

FIG. 14 is a perspective view of a casing part of FIG. 12 as viewed from the first main surface side.

FIG. 15 is a side view schematically illustrating an installation state of a surface light source according to another embodiment of the present invention.

### BEST MODE FOR CARRYING OUT THE INVENTION

Hereinafter, embodiments of the present invention will be described in detail.

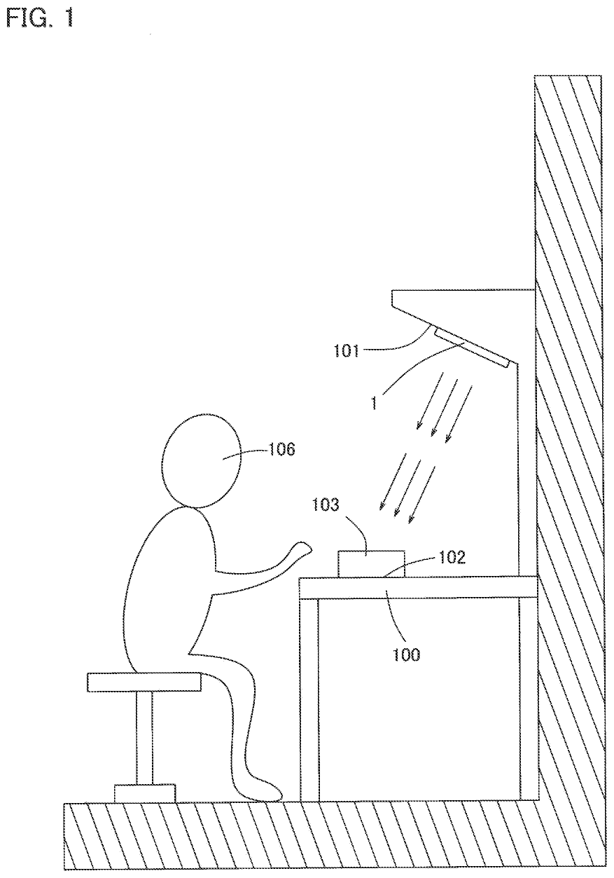

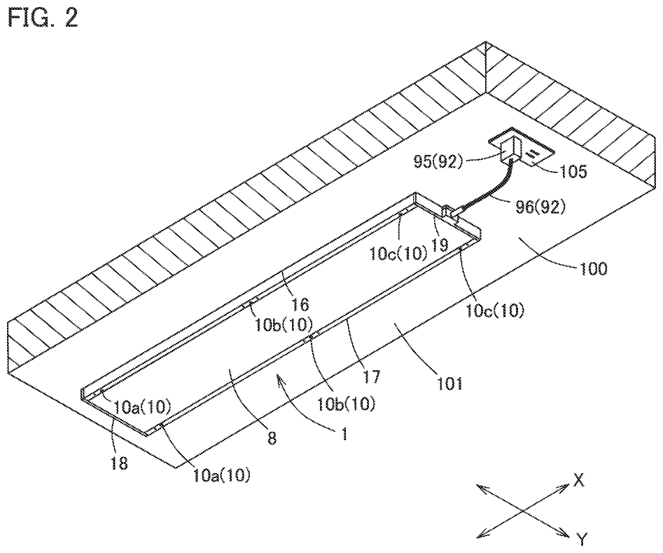

As illustrated in FIGS. 1 and 2, a surface light source 1 according to a first embodiment of the present invention is a light source for inspection with which a worker 106 inspect a work object 103, is attached to a mounting surface 101 of a workbench 100, and emits inclined light to a work surface 102.

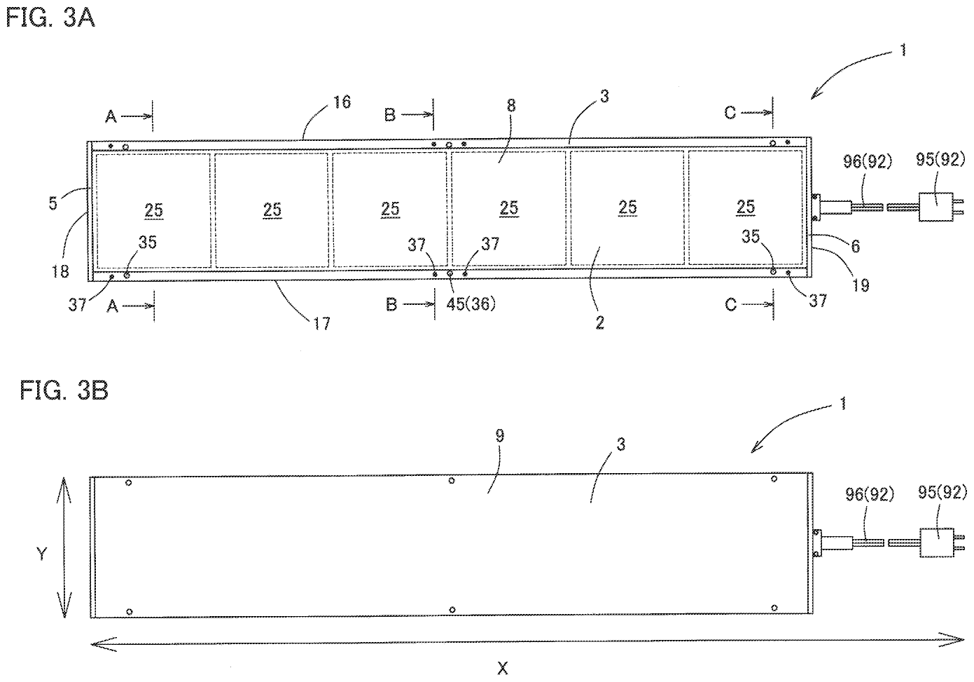

As illustrated in FIGS. 3A and 3B, the surface light source 1 is a plate-shaped light source having a first main surface 8 (emission surface) and a second main surface 9 (back surface) as both main surfaces.

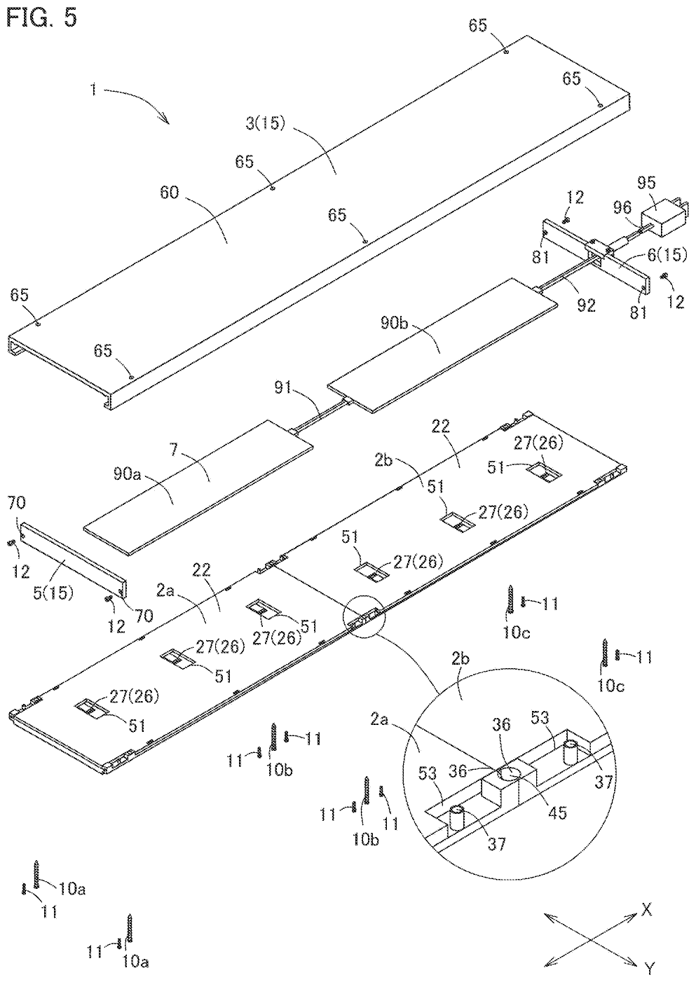

As illustrated in FIG. 5, the surface light source 1 includes a plurality of light-emitting units 2a, 2b, a casing part 3, end face-side cover parts 5, 6, a power supply control member 7, and fastening elements 10 to 12, and an exterior part 15 is constituted by the casing part 3 and the end face-side cover parts 5, 6.

As illustrated in FIG. 3A, the exterior part 15 has a horizontally long rectangular shape having a width in a longitudinal direction Y and extending in a lateral direction X when viewed from the front, and has lateral sides 16, 17 and longitudinal sides 18, 19 (one side, short side).

The maximum thickness of the exterior part 15 is not particularly limited, but is preferably 5 mm or more and 10 mm or less from the viewpoint of improving the workability without protruding from the mounting surface 101 while securing strength.

In the exterior part 15, the casing part 3 forms end faces to which the lateral sides 16, 17 belong, and the end face-side cover parts 5, 6 form end faces to which the longitudinal sides 18, 19 belong.

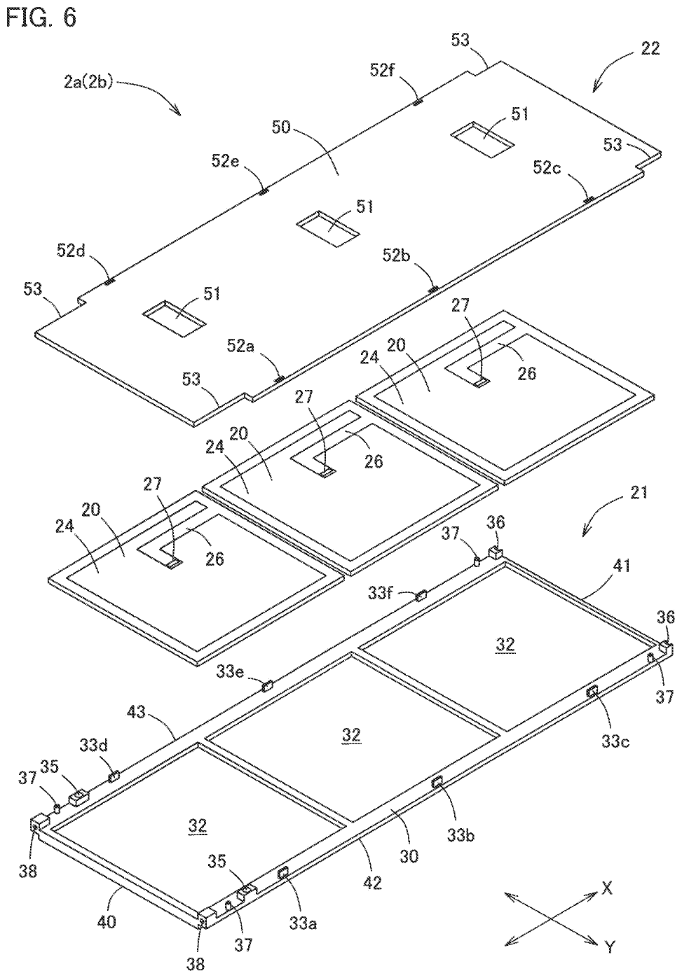

As illustrated in FIG. 6, the light-emitting units 2a, 2b include a plurality of light-emitting panels 20, a light-pervious plate 21, and a back surface plate 22.

### (Light-Emitting Panel 20)

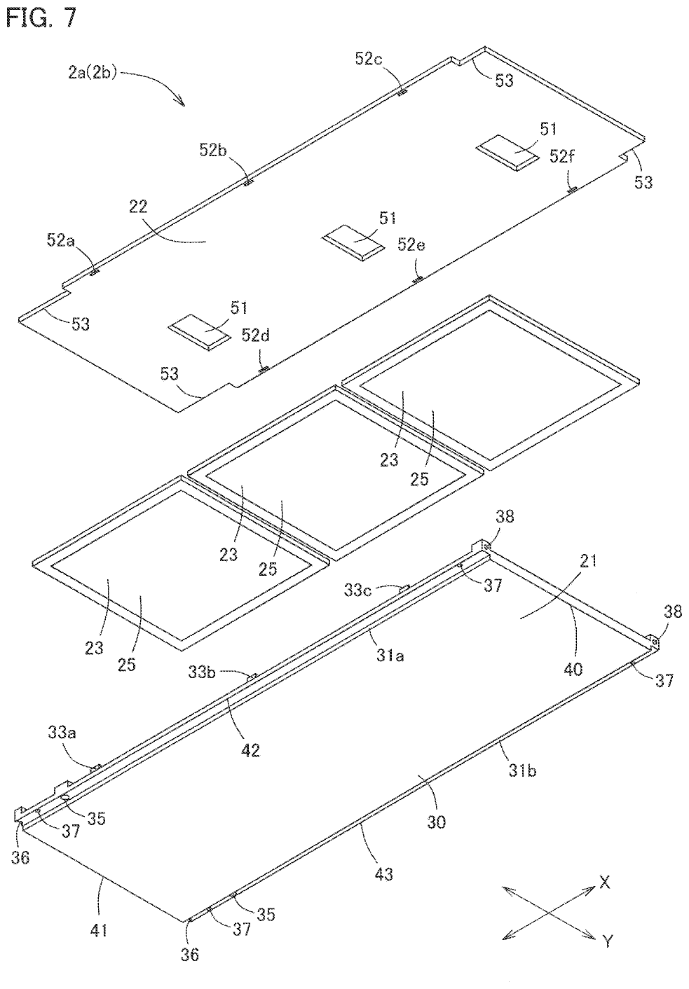

As illustrated in FIGS. 6 and 7, the light-emitting panel 20 is a plate-shaped panel having a light-emitting surface 23 and a power supply surface 24.

As illustrated in FIG. 7, the light-emitting panel 20 is a planar light-emitting panel having a light-emitting region 25 spreading in a planar shape at the center of the light-emitting surface 23, the light-emitting region 25 emits light in a planar shape at the time of lighting, and diffused light can be emitted from the light-emitting region 25.

The light-emitting panel 20 of the present embodiment is a rectangular plate-shaped panel, and is specifically an organic EL panel. Note that the light-emitting panel 20 may be an LED panel in which LEDs are dispersed in a planar shape.

As illustrated in FIG. 6, the light-emitting panel 20 includes a power-supplied portion 26 on the power supply surface 24, to which power is supplied from the power supply control member 7 (refer to FIG. 5).

The power-supplied portion 26 extends in a tongue shape from the vicinity of the end portion of the light-emitting panel 20 toward the central side, and a power supply terminal 27 is provided at the distal end.

### (Light-Pervious Plate 21)

The light-pervious plate 21 is a member that can transmit light emitted from the light-emitting region 25 of the light-emitting panel 20.

As illustrated in FIGS. 6 and 7, the light-pervious plate 21 includes a main body 30, notch parts 31a, 31b, a plurality of holding recesses 32, engagement claw portions 33a to 33f, an insertion hole 35, an insertion groove 36, a casing fastening hole 37, and an end face-side fastening hole 38.

The main body 30 is a horizontally long rectangular plate-shaped member having a width in the vertical direction Y and extending in the lateral direction X when viewed from the front.

As illustrated in FIG. 7, the main body 30 includes longitudinal sides 40, 41 extending in the vertical direction Y and lateral sides 42, 43 extending in the lateral direction X.

As illustrated in FIG. 7, the notch parts 31a, 31b are notches obtained by cutting out end portions of the main body 30 in the vertical direction Y along the lateral sides 42, 43. That is, the notch parts 31a, 31b have a width from the end portion to the central side in the vertical direction Y, and extend along the lateral sides 42, 43 along the main body 30 in the lateral direction X.

The notch parts 31a, 31b are engageable with locking wall parts 62a, 62b of the casing part 3 described later.

As illustrated in FIG. 6, the holding recess 32 is a recess that positions and holds the light-emitting panel 20, and is a bottomed hole having a depth in a thickness direction from the back surface (surface on the light-emitting panel 20 side) of the main body 30.

At least the bottom of the holding recess 32 is transparent.

The holding recesses 32 are arranged side by side at predetermined intervals in the lateral direction X.

As illustrated in FIG. 6, the engagement claw portions 33a to 33f are projecting parts provided in the vicinity of the end portions of the main body 30 in the vertical direction Y and projecting from the back surface of the main body 30.

The engagement claw portions 33a to 33c are arranged at intervals along one lateral side 42 of the main body 30, and the engagement claw portions 33d to 33f are arranged at intervals along the other lateral side 43 of the main body 30.

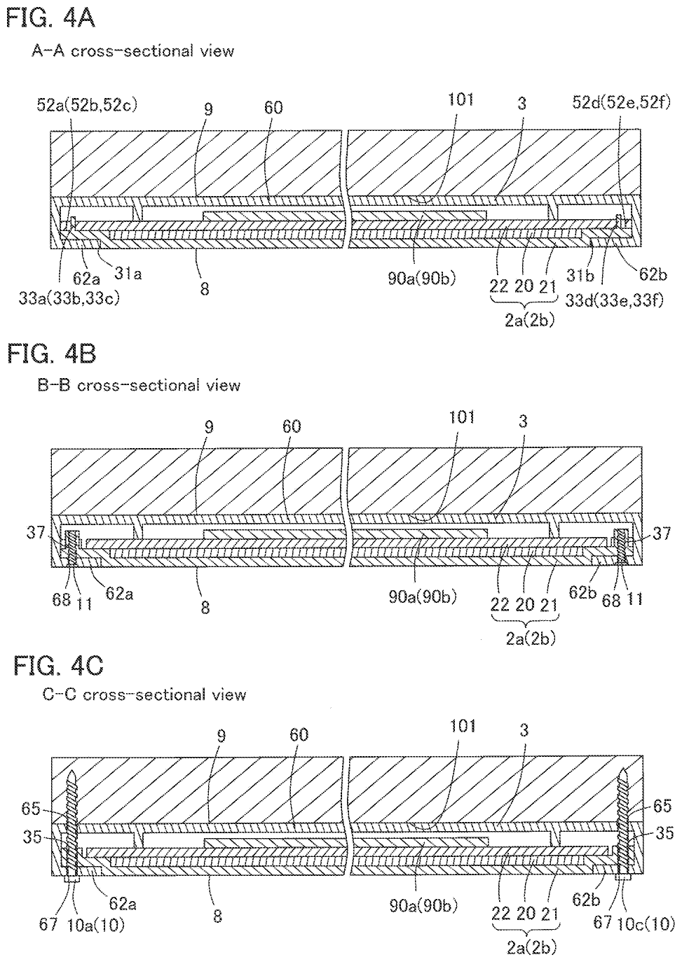

As illustrated in FIGS. 4C and 7, the insertion hole 35 is a through hole which is disposed in the notch parts 31a, 31b and penetrates the main body 30 in the thickness direction, and a wall fixing fastening element 10 can be inserted therethrough.

As illustrated in FIG. 6, the insertion groove 36 is a notched groove that is provided in the end face to which the longitudinal side 41 of the main body 30 belongs and that is cut out in the thickness direction of the main body 30.

As illustrated in FIG. 5, the insertion groove 36 can form an insertion slot 45 through which the wall fixing fastening element 10 can be inserted, together with the insertion groove 36 of the other light-emitting unit 2b (2a) when the other light-emitting unit 2b (2a) is coupled.

As illustrated in FIGS. 4B and 7, the casing fastening hole 37 is a screw hole which is disposed in the notch parts 31a, 31b and penetrates the main body 30 in the thickness direction, and can be fastened to a casing fastening element 11.

As illustrated in FIG. 7, the end face-side fastening hole 38 is a threaded hole provided in the end face of the main body 30 in the lateral direction X and having a depth inward in the lateral direction X of the main body 30, and can be fastened to an end face-side fastening element 12 (refer to FIG. 5).

### (Back Surface Plate 22)

The back surface plate 22 is a reinforcing plate that reinforces the rear side of each light-emitting panel 20, and is a heat dissipation member that has high thermal conductivity and soaks and dissipates heat generated in each light-emitting panel 20.

As illustrated in FIG. 6, the back surface plate 22 includes a plate body 50, a power supply through hole 51, locking holes 52a to 52f, and a notch part 53.

The plate body 50 is a horizontally long rectangular plate member having a width in the vertical direction Y and extending in the lateral direction X when viewed from the front.

The power supply through hole 51 is a through hole penetrating the plate body 50 in the thickness direction, and is a connection hole for connecting each light-emitting panel 20 and the power supply control member 7.

As illustrated in FIG. 6, the locking holes 52a to 52f are engagement holes engageable with the engagement claw portions 33a to 33f, and are through holes penetrating the plate body 50 in the thickness direction.

The locking hole 52a to 52c are arranged at positions corresponding to the engagement claw portions 33a to 33c, and the locking holes 52d to 52f are arranged at positions corresponding to the engagement claw portions 33d to 33f.

The notch parts 53 are notches obtained by cutting out four corners of the plate body 50.

### (Casing Part 3)

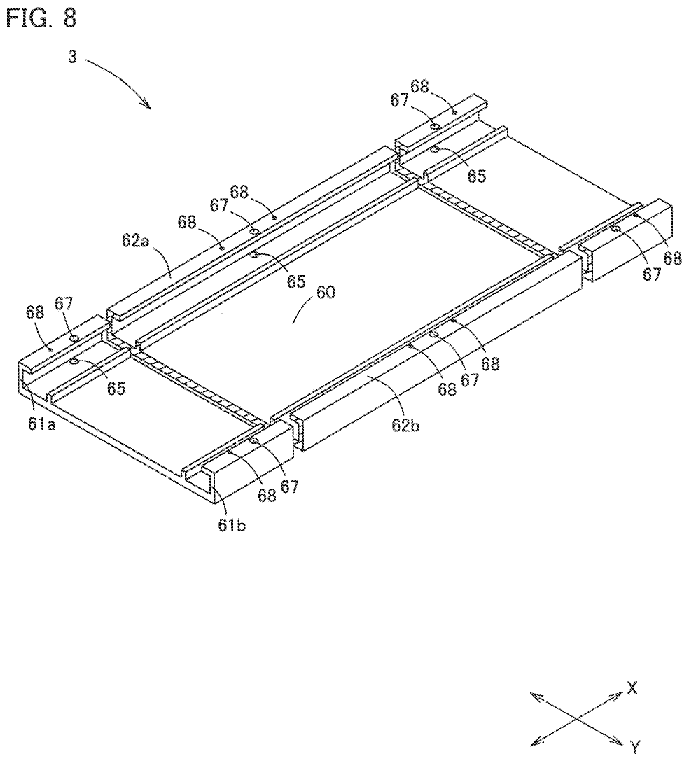

As illustrated in FIG. 8, the casing part 3 includes a rear side wall part 60, end face-side wall parts 61a and 61b, and locking wall parts 62a, 62b.

The rear side wall part 60 is a part that covers the rear sides of the light-emitting units 2a, 2b, and includes a wall fixing through hole 65.

The wall fixing through hole 65 is a through hole penetrating in the thickness direction, and is an insertion slot through which the wall fixing fastening element 10 can be inserted.

The end face-side wall parts 61a, 61b are vertical wall parts rising from respective end portions of the rear side wall part 60 in the vertical direction Y, and are connecting wall parts that connect the rear side wall part 60 and the locking wall part 62a or connect the rear side wall part 60 and the locking wall part 62b.

As illustrated in FIG. 8, the locking wall parts 62a, 62b are opposing wall parts erected from the distal ends of the end face-side wall parts 61a, 61b in the rising direction and facing the rear side wall part 60 with an interval therebetween.

The locking wall parts 62a, 62b are engageable with the notch parts 31a, 31b (refer to FIG. 7) of the light-pervious plate 21.

The locking wall parts 62a, 62b include a wall fixing through hole 67 and a plate through hole 68.

As illustrated in FIG. 4C, the wall fixing through hole 67 is a through hole penetrating the locking wall parts 62a, 62b in the thickness direction, and is an insertion slot through which the wall fixing fastening element 10 can be inserted.

The wall fixing through hole 67 faces the wall fixing through hole 65 of the rear side wall part 60 with a space interposed therebetween.

As illustrated in FIG. 4B, the plate through hole 68 is a through hole penetrating the locking wall parts 62a, 62b in the thickness direction, and is an insertion slot through which the casing fastening element 11 can be inserted.

### (End Face-Side Cover Parts 5, 6)

As illustrated in FIG. 5, the end face-side cover parts 5, 6 are end face covers that close the end faces of the casing part 3 in the lateral direction X, and are members that constitute the end faces of the surface light source 1.

The first end face-side cover part 5 includes an end face-side through hole 70.

The end face-side through hole 70 is a through hole penetrating in the thickness direction, and is an insertion slot through which the end face-side fastening element 12 can be inserted.

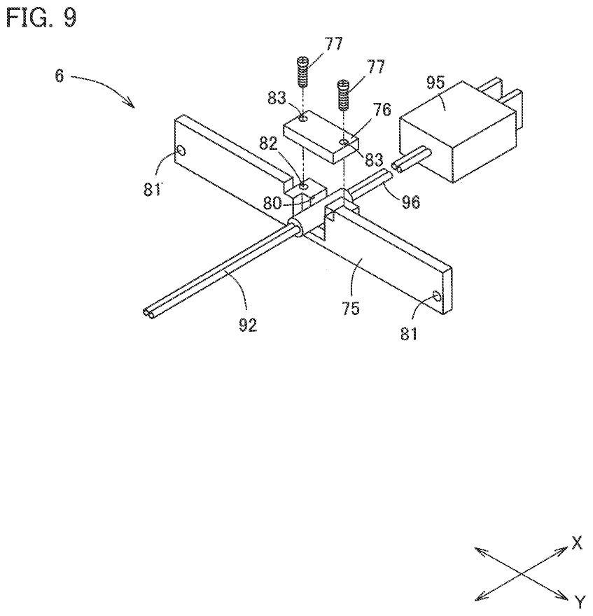

As illustrated in FIG. 9, the second end face-side cover part 6 includes a cover main body 75, a wiring regulating part 76, and a cover fastening element 77, and the wiring regulating part 76 is non-destructively attachable to and detachable from the cover main body 75.

As illustrated in FIG. 9, the cover main body 75 includes a wiring notch 80, an end face-side through hole 81, and a cover-side fastening hole 82.

The wiring notch 80 is a notch cut out from the end face on the rear side in the thickness direction of the surface light source 1 toward the front side, and a plug wiring portion 96 of the power supply control member 7 can be inserted through the wiring notch 80.

The end face-side through hole 81 is a through hole penetrating the cover main body 75 in the lateral direction X, and is an insertion slot through which the end face-side fastening element 12 (refer to FIG. 5) can be inserted.

The cover-side fastening hole 82 is a bottomed hole having a depth from the end face on the second main surface 9 (back surface) side in the thickness direction of the surface light source 1 toward the first main surface 8 (front surface) side, and can be fastened to the cover fastening element 77.

The wiring regulating part 76 is a member that regulates the plug wiring portion 96 of the power supply control member 7 in the wiring notch 80 of the cover main body 75.

The wiring regulating part 76 includes a plurality of regulating side through holes 83.

The regulating side through hole 83 is a through hole penetrating the wiring regulating part 76 in the thickness direction, and is an insertion slot through which the cover fastening element 77 can be inserted.

The cover fastening element 77 is a fixing member that fixes the wiring regulating part 76 to the cover main body 75, and specifically, is a screw portion having a head part and a shaft portion.

### (Power Supply Control Member 7)

The power supply control member 7 is a member that controls power supply to each light-emitting panel 20 of the light-emitting units 2a, 2b, and includes control boards 90a, 90b, a connection wiring line 91, and a feeding wiring line 92 as illustrated in FIG. 5.

The control boards 90a, 90b are power supply boards that include power supply terminals (not illustrated) in contact with the power supply terminals 27 of the respective light-emitting panels 20, and are capable of individually supplying power to the power supply terminals 27 of the respective light-emitting panels 20.

The control boards 90a, 90b include a dimming circuit, and dimming can be individually controlled for each light-emitting panel 20.

The connection wiring line 91 is a wiring portion that connects the control boards 90a, 90b.

As illustrated in FIG. 2, the feeding wiring line 92 is a wiring line to which power is supplied from a commercial power supply outlet 105, and includes a plug portion 95 and the plug wiring portion 96.

The plug portion 95 is a plug that can be inserted into commercial power supply outlet 105.

The plug wiring portion 96 is a wiring portion that connects the control board 90b and the plug portion 95.

### (Fastening Elements 10 to 12)

As illustrated in FIGS. 2 and 5, the wall fixing fastening element 10 is a mounting member for mounting the surface light source 1 to the mounting surface 101, and specifically, is a screw portion having a head part and a shaft portion, and is a wood screw with a pointed tip of the shaft portion.

As illustrated in FIG. 5, the casing fastening element 11 is a fixing member that fixes the light-emitting units 2a, 2b to the casing part 3.

The end face-side fastening element 12 is a fixing member that fixes the end face-side cover parts 5, 6 to the light-emitting units 2a, 2b.

### (Workbench 100)

As illustrated in FIG. 1, the workbench 100 includes the mounting surface 101 to which the surface light source 1 is attached, and the work surface 102 on which the work object 103 is placed.

The mounting surface 101 faces the work surface 102 with an interval therebetween, and is inclined at a predetermined inclination angle with respect to the work surface 102.

The inclination angle of the mounting surface 101 with respect to the work surface 102 (an angle formed by a first reference surface passing on the work surface 102 and a second reference surface passing on the mounting surface 101) is preferably equal to or greater than 0 degrees and less than 90 degrees, and more preferably more than 0 degrees and equal to or less than 45 degrees.

In the workbench 100 of the present embodiment, the work surface 102 is a horizontal plane, and the mounting surface 101 is inclined with respect to the horizontal plane.

Next, a positional relationship of each member in a state where the surface light source 1 of the present embodiment is attached to the workbench 100 will be described.

As illustrated in FIGS. 4A, 4B, and 4C, the surface light source 1 is attached such that the second main surface 9 is parallel to the mounting surface 101, and is in surface contact with the mounting surface 101.

In the surface light source 1, the second main surface 9 is a flat surface, and it is preferable that the surface light source 1 is in surface contact with the mounting surface 101 in a range of 90% or more, and it is more preferable that the surface light source 1 is in surface contact with the mounting surface 101 in a range of 95% or more.

In the surface light source 1 of the present embodiment, the entire second main surface 9 is in surface contact with the mounting surface 101.

As illustrated in FIG. 1, in the surface light source 1, the first main surface 8 faces the inclination direction with respect to the work surface 102, following the inclination of the mounting surface 101.

As can be seen from FIG. 6, in the light-emitting units 2a, 2b, the light-emitting panels 20 are housed in the holding recesses 32 of the light-pervious plate 21, and are arranged side by side in the lateral direction X (longitudinal direction).

In each light-emitting panel 20, the light-emitting surface 23 is covered with the bottom of the holding recess 32 of the light-pervious plate 21, and light emitted from the light-emitting region 25 can be transmitted through the light-pervious plate 21 and emitted outside.

As illustrated in FIG. 6, in the light-emitting units 2a, 2b, the back surface plate 22 is disposed across respective light-emitting panels 20 in the lateral direction X, and the back surface plate 22 covers the power supply surface 24 of each light-emitting panel 20 and is in surface contact with the power supply surface 24.

As illustrated in FIG. 5, in each of the light-emitting panels 20, the power supply terminal 27 of the power-supplied portion 26 is exposed from the power supply through hole 51 of the back surface plate 22, and the power supply terminal 27 of the power-supplied portion 26 is connected to the power supply terminal of the control board 90a (control board 90b) at a position overlapping with the power supply through hole 51 when viewed from the back.

As can be seen from FIG. 6, in the light-pervious plate 21, the engagement claw portions 33a to 33f are engaged with the locking holes 52a to 52f of the back surface plate 22.

As illustrated in FIG. 4, in the casing part 3, the light-emitting units 2a, 2b are disposed in a space between the rear side wall part 60 and the locking wall parts 62a, 62b, the locking wall part 62a is engaged with the notch part 31a, and the locking wall part 62b is engaged with the notch part 31b.

The surfaces of the locking wall parts 62a, 62b on the first main surface 8 side form the same flat surface as and are flush with the surface of the light-pervious plate 21 on the first main surface 8 side.

As can be seen from FIG. 5, the first end face-side cover part 5 covers an end face on one side (outer side) of the light-emitting unit 2a in the lateral direction X, and the second end face-side cover part 6 covers an end face on the other side (outer side) of the light-emitting unit 2b.

As illustrated in FIG. 9, the shaft portion of the cover fastening element 77 is inserted from the rear side of the wiring regulating part 76, passes through the regulating side through hole 83 of the wiring regulating part 76, and is engaged with the cover-side fastening hole 82 of the cover main body 75.

In the power supply control member 7, the control board 90a is provided across the power supply terminals 27 of the respective light-emitting panels 20 belonging to the light-emitting unit 2a, and power can be supplied to each light-emitting panel 20. In addition, in the power supply control member 7, the control board 90b is provided across the power supply terminals 27 of the respective light-emitting panels 20 belonging to the light-emitting unit 2b, and power can be supplied to each light-emitting panel 20.

As can be seen from FIG. 9, in the power supply control member 7, the plug wiring portion 96 of the feeding wiring line 92 passes through a wiring opening formed by the wiring notch 80 and the wiring regulating part 76 inside and outside, and the plug portion 95 is exposed to the outside of the second end face-side cover part 6.

As illustrated in FIG. 4C, the shaft portions of the wall fixing fastening elements 10a, 10c provided in the vicinity of the end portion in the lateral direction X pass through the wall fixing through hole 67, the insertion hole 35, and the wall fixing through hole 65 to be engaged with the mounting surface 101.

As illustrated in FIG. 5, the insertion groove 36 of the light-emitting unit 2a overlaps the insertion groove 36 of the adjacent light-emitting unit 2b in the lateral direction X to form one insertion slot 45, and the wall fixing fastening element 10b on the central side passes through the wall fixing through hole 67, the insertion slot 45, and the wall fixing through hole 65 to be engaged with the mounting surface 101.

As illustrated in FIG. 4B, the shaft portion of the casing fastening element 11 is inserted from the first main surface 8 (front surface) side, passes through the plate through hole 68 of the casing part 3, and is engaged with the casing fastening hole 37 of the light-pervious plate 21.

As illustrated in FIG. 5, the shaft portions of the end face-side fastening elements 12 are inserted from the outside in the lateral direction X, pass through the end face-side through holes 70, 81 of the end face-side cover parts 5, 6, and are engaged with the end face-side fastening holes 38, 38 of the light-pervious plates 21, 21.

With the surface light source 1 of the present embodiment, the feeding wiring line 92 extends from the end face to which the longitudinal side 19 of the exterior part 15 belongs, and the feeding wiring line 92 is not positioned between the second main surface 9 which is the back surface of the surface light source 1 and the mounting surface 101. Therefore, the thickness of the surface light source 1 can be made thinner than the thickness of those in the related art, and the surface light source 1 can be attached to a desired mounting surface 101 by fixing means such as a fastening element or an adhesive. Therefore, the surface light source 1 can be installed on the desired mounting surface 101 without any additional processing, and there are few restrictions on the installation place.

With the surface light source 1 of the present embodiment, since the feeding wiring line 92 includes the plug portion 95 connectable to the commercial power supply outlet 105, power can be easily supplied from the commercial power supply outlet 105 by inserting the plug portion 95 of the feeding wiring line 92 into the commercial power supply outlet 105.

With the surface light source 1 of the present embodiment, since the exterior part 15 is thin, the surface light source 1 does not protrude from the mounting surface 101, and workability can be improved when inspection or the like is performed.

With the surface light source 1 of the present embodiment, since the feeding wiring line 92 extends from the edge surface to which the longitudinal side 19 as the short side of the exterior part 15 belongs, the feeding wiring line 92 is less likely to be an obstacle, and the vertical width can be narrowed.

With the surface light source 1 of the present embodiment, since a wood screw is used as the wall fixing fastening element 10 and the surface light source 1 is attached to the mounting surface 101 by the wall fixing fastening element 10, it is easy to fix.

With the surface light source 1 of the present embodiment, since the second main surface 9 as the back surface of the exterior part 15 is a flat surface and the surface light source 1 is in surface contact with the mounting surface 101 in a range of 90% or more, the second main surface 9 of the exterior part 15 is supported by the mounting surface 101, and the exterior part 15 is hardly deformed.

With the surface light source 1 of the present embodiment, since light is emitted in the inclination direction with respect to the work surface 102 of the workbench 100, a shadow is less likely to be formed on the work surface 102 of the workbench 100.

With the surface light source 1 of the present embodiment, the surfaces of the locking wall parts 62a, 62b on the first main surface 8 side are flush with the surface of the light-pervious plate 21 on the first main surface 8 side. That is, in the surface light source 1, since the first main surface 8 has a flat surface shape, dust and the like are less likely to accumulate and cleaning is easy.

Subsequently, a surface light source 201 of a second embodiment of the present invention will be described. Note that description of the same configuration as that of the surface light source 1 of the first embodiment will be omitted as necessary. The same applies hereinafter.

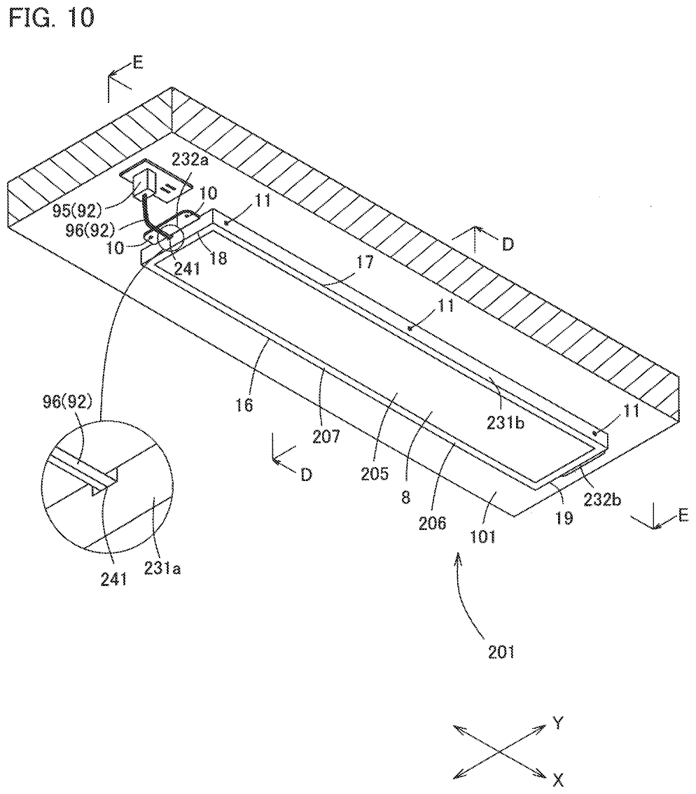

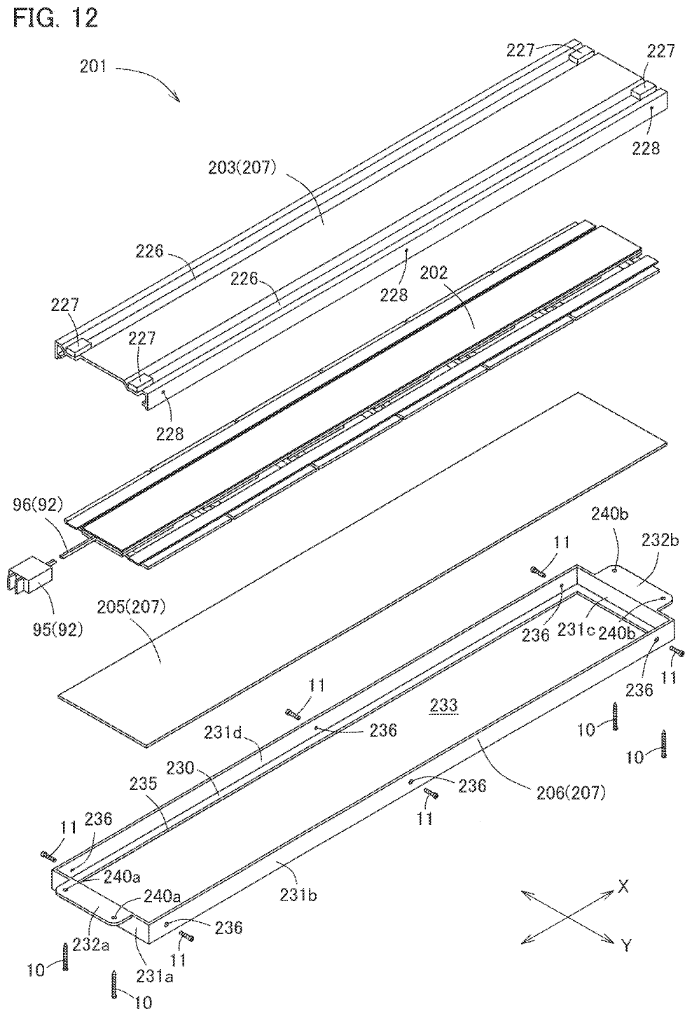

As illustrated in FIGS. 10 and 12, the surface light source 201 of the second embodiment of the present invention includes a light-emitting unit 202, a casing part 203, a light-pervious plate 205, a light-emitting-side cover part 206, a wall fixing fastening element 10, and a casing fastening element 11, and the casing part 203, the light-pervious plate 205, and the light-emitting-side cover part 206 constitute an exterior part 207.

When viewed from the front as illustrated in FIG. 10, the exterior part 207 has a horizontally long rectangular shape having a width in the vertical direction Y and extending in the lateral direction X, and has lateral sides 16, 17 and longitudinal sides 18, 19 (one side).

### (Light-Emitting Unit 202)

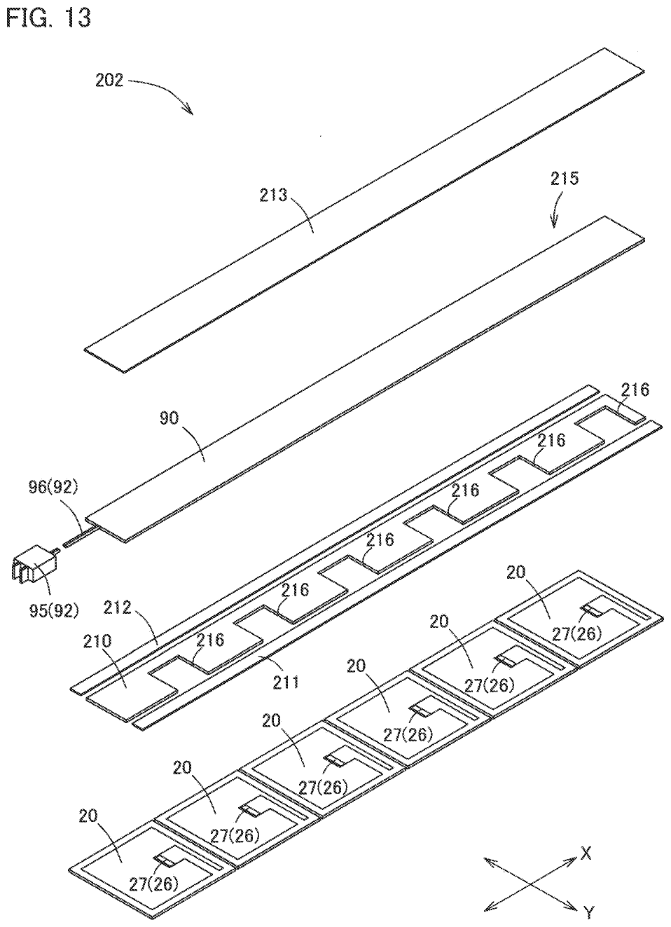

As illustrated in FIG. 13, the light-emitting unit 202 includes a plurality of light-emitting panels 20, heat dissipation members 210 to 213, and a power supply control member 215.

The heat dissipation members 210 to 213 are reinforcing plates that reinforce the rear side of each light-emitting panel 20, and are members that equalize and dissipate heat generated in each light-emitting panel 20.

As illustrated in FIG. 13, the heat dissipation member 210 is a long plate-shaped member extending in the lateral direction X, and includes a plurality of notch parts 216 cut out from one end portion in the vertical direction Y toward the central side.

The notch part 216 is provided to avoid the power supply terminal 27 of each light-emitting panel 20.

The heat dissipation members 211 to 213 are long plate-shaped members extending in the lateral direction X.

The power supply control member 215 is a member that controls power supply to each light-emitting panel 20 of the light-emitting unit 202, and includes a control board 90, and a feeding wiring line 92.

### (Casing Part 203)

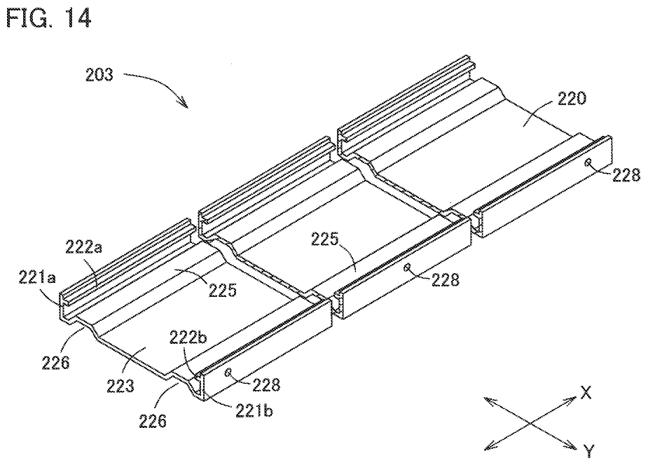

As illustrated in FIG. 14, the casing part 203 includes a rear side wall part 220, end face-side wall parts 221a, 221b, and locking wall parts 222a, 222b.

The rear side wall part 220 is a part covering the second main surface 9 (back surface) side of the light-emitting unit 202, and includes a base portion 223 and a raised part 225.

The raised part 225 is a part raised with respect to the base portion 223, and is a ridge part extending in the lateral direction X.

In addition, when viewed from the first main surface 8 (front surface) side, a recess 226 is formed at a position corresponding to the raised part 225 in the rear side wall part 220.

The recess 226 is a part recessed with respect to the base portion 223, and is a recessed groove extending in the lateral direction X.

As illustrated in FIG. 12, one or a plurality of magnetic force generators 227 are provided at the bottom of the recess 226.

The magnetic force generator 227 is a part that generates a magnetic force, and is specifically a permanent magnet.

The plurality of magnetic force generators 227 of the present embodiment are provided in the vicinity of four corners of the casing part 203.

As illustrated in FIG. 14, the end face-side wall parts 221a, 221b are vertical wall parts rising from the end portions of the rear side wall part 220 in the vertical direction Y, and include fastening holes 228 in the middle section in the rising direction.

The fastening holes 228 are through holes or bottomed holes that can be fastened with the casing fastening element 11, and are arranged at intervals in the lateral direction X.

The locking wall parts 222a, 222b are protruding portions protruding from the middle section of the end face-side wall parts 221a, 221b in the rising direction, and are parts that support the light-pervious plate 205.

### (Light-Pervious Plate 205)

As illustrated in FIG. 12, the light-pervious plate 205 is a transparent plate having translucency, and is a rectangular plate material.

The light-pervious plate 205 is a protective member that protects the light-emitting surface 23 of each light-emitting panel 20 of the light-emitting unit 202, and can transmit light emitted from each light-emitting panel 20.

### (Light-Emitting-Side Cover Part 206)

As illustrated in FIG. 12, the light-emitting-side cover part 206 includes a light-emitting-side wall part 230, end face-side wall parts 231a to 231d, and mounting parts 232a, 232b, and an enclosed space 233 surrounded by the wall parts 230, 231a to 231d is formed.

The light-emitting-side wall part 230 is a rectangular-shaped plate-like portion, and includes a light extraction hole 235 at a central portion.

The light extraction hole 235 is a through hole penetrating the light-emitting-side wall part 230 in the thickness direction, and an opening shape of the light extraction hole 235 is a quadrangular shape.

The end face-side wall parts 231a to 231d are wall parts rising from the four sides of the light-emitting-side wall part 230, and are enclosed wall parts surrounding the light-emitting unit 202.

The end face-side wall parts 231b, 231d facing each other in the vertical direction Y include cover-side through holes 236.

The cover-side through hole 236 is a through hole penetrating in the thickness direction, and is an insertion slot through which the casing fastening element 11 can be inserted.

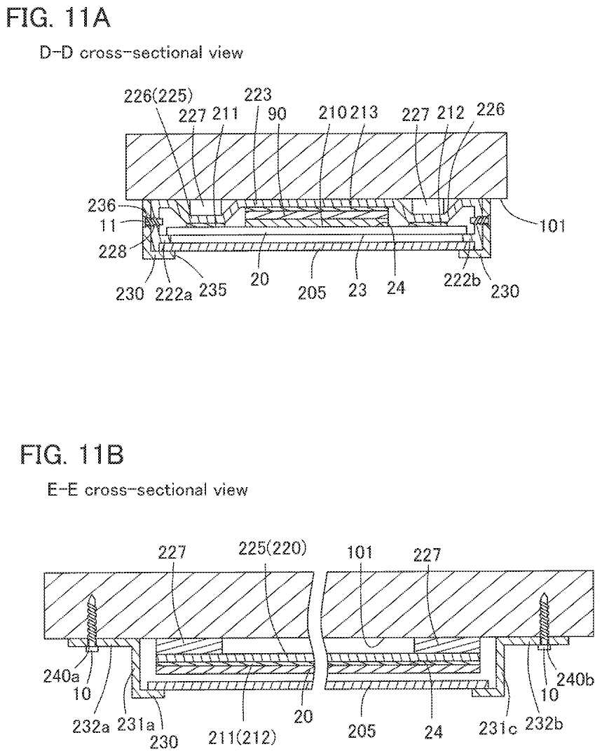

As illustrated in FIG. 11B, the mounting parts 232a, 232b are parts to which the surface light source 201 is attached to the mounting surface 101, and are projecting pieces projecting outward from the end portions of the end face-side wall parts 231a, 231c, which face each other in the lateral direction X, in the rising direction.

As illustrated in FIG. 12, the mounting parts 232a, 232b include a plurality of mounting holes 240a, 240b.

The mounting holes 240a, 240b are through holes penetrating the mounting parts 232a, 232b in the thickness direction, and are insertion slots through which the shaft portions of the wall fixing fastening elements 10 can be inserted.

Subsequently, the positional relationship of the members of the surface light source 201 according to the present embodiment will be described.

As illustrated in FIG. 11, the light-pervious plate 205 is disposed in the enclosed space 233 to cover the light extraction hole 235 of the light-emitting-side cover part 206 from the second main surface 9 (back surface) side, and is sandwiched between the locking wall parts 222a, 222b of the casing part 203 and the light-emitting-side wall part 230 of the light-emitting-side cover part 206.

The light-pervious plate 205 faces the light-emitting surface 23 of each light-emitting panel 20 with an interval therebetween.

The heat dissipation members 210 to 212 are placed on the power supply surfaces 24 of the plurality of light-emitting panels 20.

As can be seen from FIG. 13, the control board 90 is placed on the back surface of the heat dissipation member 210, and the heat dissipation member 213 is placed on the back surface of the control board 90. That is, the control board 90 is sandwiched between the heat dissipation members 210, 213, and is connected to the power-supplied portion 26 of the light-emitting panel 20 via the notch part 216 of the heat dissipation member 210.

As illustrated in FIG. 11A, the heat dissipation members 211, 212 are in surface contact with the distal end of the raised part 225, and the heat dissipation member 213 is in surface contact with the base portion 223.

The casing fastening element 11 is inserted from the outside in the vertical direction Y, passes through the cover-side through hole 236 of the light-emitting-side cover part 206, and is engaged with the fastening hole 228 of the casing part 203.

With the surface light source 201 of the second embodiment, the mounting parts 232a, 232b protrude outward in the lateral direction X from the end face-side wall parts 231a, 231c belonging to the longitudinal sides 18, 19 as short sides, and a wiring line through hole 241 that can pass through the plug wiring portion 96 is provided in the end face-side wall part 231a belonging to the longitudinal side 18, so that the plug wiring portion 96 is less likely to be an obstacle.

With the surface light source 201 of the second embodiment, since the magnetic force generator 227 is provided on the rear side wall part 220 of the casing part 203, it is possible to easily mount the surface light source 201 onto the mounting surface 101 when a magnetic body is included in the mounting surface 101.

In the first embodiment described above, the surface light source 1 includes the two light-emitting units 2a, 2b, but the present invention is not limited thereto. The surface light source 1 may include one light-emitting unit 2 or three or more light-emitting units 2.

In the first embodiment described above, each of the light-emitting units 2a, 2b includes three light-emitting panels 20, but the present invention is not limited thereto, and the number of light-emitting panels 20 mounted on the light-emitting units 2a, 2b is not particularly limited. One light-emitting panel 20 may be mounted on one light-emitting unit 2, or two light-emitting panels 20 may be mounted on one light-emitting unit 2. In addition, four or more light-emitting panels 20 may be mounted on one light-emitting unit 2.

In the embodiments described above, the case where the surface light sources 1 and 201 are attached to the mounting surface 101 of the workbench 100 has been described, but the present invention is not limited thereto. A wall surface such as a ceiling, a wall, or a floor of the fixed structure may be used as the mounting surface 101.

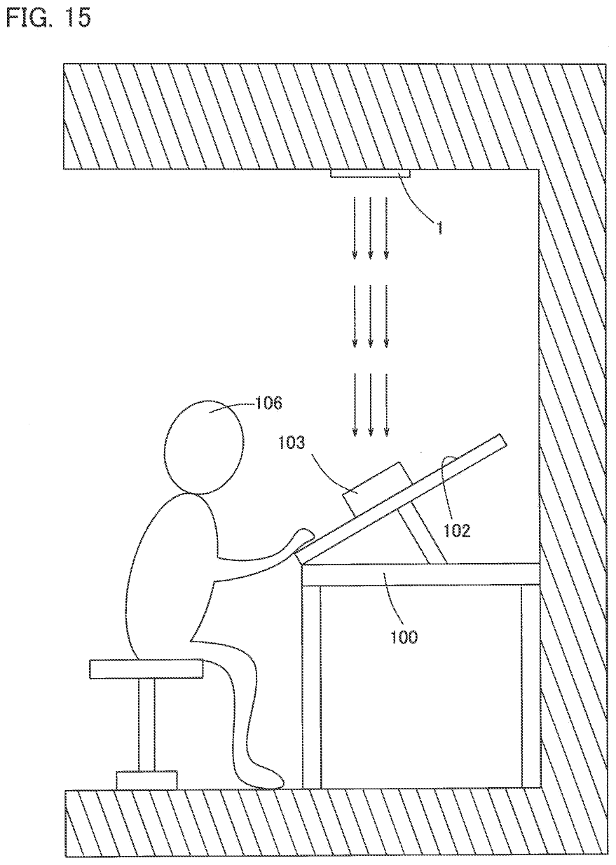

For example, as illustrated in FIG. 15, the ceiling surface may be the mounting surface 101.

In the above-described embodiment, the case where the work surface 102 is the horizontal plane, and the surface light sources 1 and 201 are attached to the workbench 100 in which the mounting surface 101 is inclined with respect to the horizontal plane has been described, but the present invention is not limited thereto. As illustrated in FIG. 15, the surface light sources 1 and 201 may be attached to the workbench 100 in which the mounting surface 101 is horizontal and the work surface 102 is inclined with respect to the horizontal plane.

In the embodiments described above, the second main surface 9 as the back surface of the exterior part 15 is brought into surface contact directly with the mounting surface 101, but the present invention is not limited thereto. A thin sheet such as wallpaper or a resin sheet may be interposed between the second main surface 9 of the exterior part 15 and the mounting surface 101.

In the embodiments described above, the case where the surface light sources 1, 201 are installed on the workbench 100 and used as a work lighting device has been described, but the present invention is not limited thereto. The surface light sources 1, 201 may be used as a normal lighting fixture.

In the embodiments described above, the surface light sources 1, 201 have a quadrangular shape when viewed from the front, but the present invention is not limited thereto, and the surface light sources 1, 201 may have a shape having at least one side. For example, the surface light sources 1, 201 may have a polygonal shape such as a triangular shape, a pentagonal shape, or a hexagonal shape when viewed from the front.

In the embodiments described above, each component member can be freely replaced or added between the embodiments as long as it is included in the technical scope of the present invention.

### REFERENCE CHARACTER LIST

1, 201: surface light source
8: first main surface (emission surface)
9: second main surface (back surface)
10, 10a to 10c: wall fixing fastening element
15, 207: exterior part
18, 19: longitudinal side (one side, short side)
20: light-emitting panel
92: feeding wiring line
95: plug portion
100: workbench
101: mounting surface
102: work surface
105: commercial power supply outlet

1. A surface light source that includes: an emission surface; and a back surface attached to a mounting surface such that the back surface is parallel to the mounting surface, the surface light source comprising:
an exterior part;
a plurality of light-emitting panels; and
a feeding wiring line,
wherein the exterior part has one side when the emission surface is viewed in plan view, and
wherein the feeding wiring line is connected to the plurality of light-emitting panels in the exterior part, the feeding wiring line extending to an outside from an end face to which the one side of the exterior part belongs.

2. The surface light source according to claim 1, wherein the feeding wiring line includes a plug portion configured to be inserted into a commercial power supply outlet.

3. The surface light source according to claim 1, wherein a maximum thickness of the exterior part is equal to or greater than 5 mm and equal to or less than 10 mm.

4. The surface light source according to claim 1,
wherein the exterior part has a rectangular shape when the emission surface is viewed in plan view,
wherein the plurality of light-emitting panels are arranged side by side in a longitudinal direction, and
wherein the feeding wiring line extends to an outside from an end face to which a short side of the exterior part belongs.

5. The surface light source according to claim 1, wherein the exterior part is fixed to the mounting surface by a fastening element.

6. The surface light source according to claim 5, wherein a back surface of the exterior part is in surface contact with the mounting surface directly or with a sheet interposed therebetween so that the back surface is fixed to the mounting surface.

7. The surface light source according to claim 1, wherein the surface light source is for use of inspection, the surface light source emitting light to a work surface of a workbench in an inclination direction.
